(19) United States
(12) Patent Application Publication
(10) Pub. No.: US 2012/0114890 A1
(43) Pub. Date: May 10, 2012

(54) POLYPHENYLSULPHONE-POLYTETRAFLUOROETHYLENE COMPOSITIONS AND USE THEREOF

(75) Inventors: Detlef Bumann, Alsbach-Haehnlein (DE); Albert Drexler, Hoechst/Odw (DE); Ricardo Luiz Willemann, Shanghai (CN)

(73) Assignee: EVONIK ROEHM GmbH, Darmstadt (DE)

(21) Appl. No.: 13/383,314

(22) PCT Filed: May 25, 2010
(86) PCT No.: PCT/EP2010/057125

§ 371 Date: Jan. 10, 2012

(30) Foreign Application Priority Data
Jul. 13, 2009 (DE) 10 2009 027 659.9

(51) Int. Cl. B32B 1/08; C08L 81/06; B29B 9/06

(52) U.S. Cl. 428/36.9; 264/141; 525/150

(57) ABSTRACT

The invention relates to a method for producing plastic molded bodies, characterised in that the two plastic materials PPSU and PTFE are mixed with one another at a temperature of 340 degrees Celsius to 385 degrees Celsius in an extruder, the resulting compound is granulated and the granules are extruded into plastic molded bodies at a screw temperature of 370 degrees Celsius to 390 degrees Celsius. The plastic molded bodies obtained are used as anti-wear tapes in oil delivery pipes.

### FIELD OF THE INVENTION

The invention relates to a mixture made of polyphenyl sulphone (PPSU) and polytetrafluoroethylene (PTFE) for producing friction-reducing tapes which are used as friction-reducing interlay for flexible fluid pipelines, examples being oil-conveying pipelines (anti-wear tapes).

### PRIOR ART

GB 2 441 066 (Technip France) describes a flexible tube of multilayer structure for transporting hydrocarbons. Between the metal strips, which are movable with respect to one another at least to some extent, the arrangement has a friction-reducing plastics strip, and the said plastics strip is composed of an amorphous polymer with a glass transition temperature of from 175 degrees C. to 255 degrees C. The strip is composed of polyphenyl sulphone (PPSU) and of a perfluorinated polymer and of a polyether ether ketone (PEEK). In one specific embodiment of the invention, a mixture made of 85% of polyphenyl sulphone (PPSU) is mixed with 15% of polytetrafluoroethylene (PTFE) and extruded to give strips of thickness 1.5 mm and width about 1 m. Nothing is said about the molecular weights of the plastics used.

US 2005/0229991 describes an arrangement similar to that in GB '066, but in this case the material of the intermediate layer is an elastomeric thermoplastic polymer, for example a styrene-butadiene-styrene rubber (SBS), a styrene-ethylene-butadiene-styrene copolymer (SEBS) or an EPDM (ethylene-propylene-diene) copolymer, or else a polybutadiene, a polyisoprene or a polyethylene-butylene copolymer.

### OBJECT

In the light of the prior art discussed, it was therefore an object to find a material and/or a mixture of materials which can be used for the friction-reducing tapes in oil-conveying pipelines and which has/have better suitability than the materials of the prior art for the conditions prevailing in that situation (temperatures of about 130 degrees Celsius, pressures of from 300 to 400 bar).

### ACHIEVEMENT OF OBJECT

The object according to the invention is achieved by the provision of a homogeneous mixture made of a polyphenyl sulphone (PPSU) and of a polytetrafluoroethylene (PTFE) with a particularly high molecular weight and small grain size and small grain size distribution. The PTFE used has a particularly high molecular weight. However, it is particularly suitable for incorporation into engineering plastics, where these are processed at very high melt temperatures.

A decisive factor for the entire development of the solution according to the invention is that it is only very uniform dispersion of very fine-particle PTFE across the entire cross section within the PPSU matrix that provides the desired effect over the usage period in which the thickness of the tape decreases, and that provides particularly balanced mechanical properties not only in but also perpendicularly to the direction of extrusion.

### The Polyphenyl Sulphone (PPSU)

The PPSU used comprises a polyphenyl sulphone which is marketed by Solvay Advanced Polymers with trade mark RADEL® R.

The repeating unit of the polymer has the following formula:

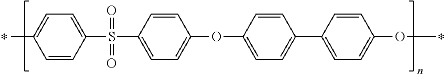

The material involved here is a transparent and high-performance plastic which has extremely high stress-cracking resistance and extremely high notched impact resistance, even after heat-ageing, and excellent chemicals resistance. The RADEL R 5000 nt used is a non-flame-retardant PPSU which does not fulfil all aviation requirements.

It is used for producing components in medical technology, in the chemical industry and in plumbing. The density of the polymer is 1.29 g/cm³ measured to ISO 1183, yield stress is 70 MPa measured to ISO 527, tensile strain at break is 60% measured to ISO 527, tensile modulus of elasticity is 2340 MPa measured to ISO 527, Izod notched impact resistance at 23 degrees Celsius is 49.4 kJ/m² measured to ISO 180/1A, and Charpy notched impact resistance at 23 degrees Celsius is 58.3 kJ/m² measured to ISO 179/1eA.

Dielectric constant at 50 Hz is 3.4 measured to IEC 60250, dielectric constant at 1 MHz is 3.5 measured to IEC 60250, and dielectric loss factor at 50 Hz is 6 1e-4 measured to IEC 60250. Dielectric loss factor at 1 MHz is 76 1e-4 measured to IEC 60250, and dielectric strength is 15 kV/mm measured to IEC 60243-1, measured to ASTM. Thickness for dielectric strength is 3.2 mm, and specific volume resistivity to IEC 60093 is 9e15 ohm m.

Longitudinal expansion along/perpendicularly to the direction of flow is 55 10 ⁻⁶ /K measured to ISO 11359, melting point or glass transition temperature measured to ISO 11357 is 215 degrees Celsius, heat-deflection temperature A is 207 degrees Celsius measured to ISO 75 HDT/A (1.8 MPa), heat-deflection temperature B is 214 degrees Celsius measured to ISO 75 HDT/A (0.45 MPa), maximum temperature (short-term) is 180 degrees Celsius, maximum temperature (long-term) is 160 degrees Celsius (heat-ageing to UL 746 (RTI) Mechanical W/O Imp., 40 000 h). Minimum usage temperature is minus 100 degrees Celsius.

### The Polytetrafluoroethylene (PTFE)

The high-molecular-weight polytetrafluoroethylene (PTFE) used is very fine-grained Zonyl® MP 1300 polytetrafluoroethylene. This PTFE has particular suitability as additive in polymer mixtures based on HT thermoplastics.

### EXAMPLES

### Compounding Examples

A mixture made of from 95% by weight to 60% by weight of PPSU and from 40% by weight to 5% by weight of PTFE was compounded in the following manner:

The PPSU is melted and devolatilized at 345° C. to 380° C. screw temperature and 250 rpm in a twin-screw extruder (producer and type: Werner & Pfleiderer ZSK25 WLE (K4)); the PTFE is introduced by way of a lateral feed aperture.

| | Example | Example | Example | Example | Example |
|---|---|---|---|---|---|
| | 1 | 2 | 3 | 4 | 5 |
| PPSU (% by | 95 | 95 | 80 | 60 | 60 |
| wt.) | | | | | |
| PTFE (% by | 5 | 5 | 20 | 40 | 40 |
| wt.) | | | | | |
| Barrel | 345 | 380 | 380 | 380 | 380 |
| temperature | | | | | |
| (degrees | | | | | |
| Celsius) | | | | | |
| Rotation | 200 | 200 | 200 | 200 | 200 |
| rate (rpm) | | | | | |
| Vacuum | 600 | 600 | 600 | 600 | 600 |
| (mbar | | | | | |
| abs.) | | | | | |

The compounded material obtained was pelletized.

The sheet according to the invention can be produced in a manner known per se via extrusion of the pellets obtained in the first step.

To this end, thermally plastified melt is produced by way of one extruder in the case of the simple extrusion process or by way of a plurality of extruders in the case of the coextrusion process, and is fed into an extrusion die. There can be additional apparatuses, e.g. a melt pump and/or a melt filter, arranged in a manner known per se between the extruder and extrusion die. The extruded webs can then be introduced into a polishing stack or into a calibrator.

The pellets were remelted and extruded to give tapes with the following dimensions: length 1 000 mm, width 150 mm and thickness 1.5 mm. Melt temperature was about 385 degrees Celsius.

### Extrusion Examples

Example 6 relates to a tape with the constitution according to Example 1; the pellets were extruded at a melt temperature of 347 degrees Celsius to give a tape.

Example 7 relates to a tape with the constitution according to Example 1; the pellets were extruded at a melt temperature of 379 degrees Celsius to give a tape.

Example 8 relates to a tape with the constitution according to Example 1; the pellets were extruded at a melt temperature of 380 degrees Celsius to give a tape.

Example 9 relates to a tape with the constitution according to Example 2; the pellets were extruded at a melt temperature of 347 degrees Celsius to give a tape.

Example 10 relates to a tape with the constitution according to Example 2; the pellets were extruded at a melt temperature of 358 degrees Celsius to give a tape.

Example 11 relates to a tape with the constitution according to Example 1; the pellets were extruded at a melt temperature of 350 degrees Celsius to give a tape.

Example 12 relates to a tape with the constitution according to Example 4 or 5; the pellets were extruded at a melt temperature of 352 degrees Celsius to give a tape.

The mechanical data for the resultant tapes were as follows:

| | Example 6 | Example 7 | Example 8 | Example 9 | Example 10 | Example 11 | Example 12 |
|---|---|---|---|---|---|---|---|
| Modulus of | 2 174 | 2 183 | 2 135 | 2 174 | 2 152 | 2 188 | 2 172 |
| elasticity in | | | | | | | |
| extrusion | | | | | | | |
| direction (MPa) | | | | | | | |
| Modulus of | 2 166 | 2 118 | 2 170 | 2 127 | 2 145 | 2 190 | 2 184 |
| elasticity | | | | | | | |
| perpendicular to | | | | | | | |
| extrusion | | | | | | | |
| direction (MPa) | | | | | | | |
| Charpy | no | no | no | no | no | no | no |
| | fracture | fracture | fracture | fracture | fracture | fracture | fracture |
| Gardner | >18 | >18 | >18 | >18 | >18 | >18 | >18 |
| Coefficient of | 0.37 | 0.35 | 0.3 | 0.29 | 0.23 | 0.26 | 0.26 |
| friction, static, | | | | | | | |
| upper surface | | | | | | | |
| Coefficient of | 0.24 | 0.23 | 0.25 | 0.24 | 0.25 | 0.2 | 0.22 |
| friction, static, | | | | | | | |
| lower surface | | | | | | | |
| Coefficient of | 0.34 | 0.35 | 0.26 | 0.28 | 0.2 | 0.26 | 0.21 |
| friction, dynamic, | | | | | | | |
| upper surface | | | | | | | |
| Coefficient of | 0.19 | 0.21 | 0.22 | 0.22 | 0.24 | 0.15 | 0.2 |
| friction, dynamic, | | | | | | | |
| lower surface | | | | | | | |

### Methods

Modulus of elasticity was determined to ISO 527-2/1BA/0.5, Charpy impact resistance was determined to ISO 179-1/1eA, and the Gardner test was carried out according to ASTM D5420, and the coefficients of friction were measured according to ISO 8295.

The resultant mixture is suitable for producing anti-wear tapes which are used for producing pipelines for fluids, examples being flexible oil-conveying pipelines.

1. A mixture, comprising:
polyphenyl sulphone (PPSU) and
polytetrafluoroethylene (PFTE),
wherein a PTFE content of the mixture is from 1% by weight to 15% by weight,
a PPSU content of the mixture is from 99% by weight to 85% by weight, and
the mixture is made by a process comprising mixing the PTFE and the PPSU at a temperature of at least 340° C. in an extruder.

2. The mixture of claim 1,
made by a process comprising mixing the PTFE and the PPSU at a temperature of from 340° C. to 385° C. in an extruder.

3. The mixture of claim 1,
wherein the PTFE content of the mixture is from 2% by weight to 10% by weight and
the PPSU content of the mixture is from 98% by weight to 90% by weight.

4. The mixture of claim 1,
wherein the PTFE content of the mixture is from 5% by weight to 10% by weight and
the PPSU content of the mixture is from 95% by weight to 90% by weight.

5. A process for producing a plastics molding, comprising:
mixing PPSU and PTFE to obtain a mixture, and
extruding the mixture.

6. The process of claim 5, comprising:
mixing the PPSU and PTFE at a temperature of from 340 degrees Celsius to 385 degrees Celsius in an extruder, to obtain a mixture,
pelletizing the mixture to obtain pellets, and
extruding the pellets at from 370 degrees Celsius to 390 degrees Celsius screw temperature to obtain a plastics molding.

7. The process of claim 5, comprising:
mixing the PPSU and PTFE at a temperature of from 345 degrees Celsius to 385 degrees Celsius in an extruder, to obtain a mixture,
pelletizing the mixture to obtain pellets, and
extruding the pellets at from 375 degrees Celsius to 390 degrees Celsius screw temperature to obtain a plastics molding.

8. A process for producing an anti-wear tape, comprising producing an anti-wear tape comprising the mixture of claim 1.

9. An anti-wear tape made by a process comprising extruding the mixture of claim 1.

10. A pipeline for a fluid, comprising:
the anti-wear tape of claim 9.
